(19) United States
(12) Patent Application Publication
(10) Pub. No.: US 2002/0031245 A1
(43) Pub. Date: Mar. 14, 2002

(54) Biometric authentification method

(76) Inventors: Roman Rozenberg, Forest Hills, NY (US); Jurij Jakovlevich Kharon, Moscow (RU)

Correspondence Address: MALLOY & MALLOY, P.A., 2800 S.W. Third Avenue, Historic Coral Way, Miami, FL, 33129, US

(21) Appl. No.: 09/861,858

(22) Filed: May 21, 2001

Related U.S. Application Data
(63) Continuation of application No. 09/459,041, filed on Dec. 10, 1999, now abandoned.
Application No. 09/459,041 is a continuation-in-part of application No. 09/312,002, filed on May 14, 1999, now Pat. No. 6,282,304.

(51) Int. Cl. G06K 9/00

(52) U.S. Cl. 382/125

(57) ABSTRACT

A biometric authentification system and method including a biometric input device structured to detect biometric data of a fingerprint placed on a scanning surface of the biometric input device, a biometric data storage assembly structured to store fingerprint reference data corresponding to an authenticated user, and a biometric comparison assembly structured to identify two minutia points and a connecting pattern therebetween in the fingerprint data, utilizing the minutia points, the connecting pattern and/or pseudo minutia points defined from the connecting pattern as comparison characteristics of the fingerprint which it compares to corresponding characteristics of the stored fingerprint reference data.

### BACKGROUND OF THE INVENTION

The present is a Continuation of U.S. patent application Ser. No. 09/459,041, filed on Dec. 10, 1999, for a Biometric Authentification System and Method Therefor, which is a Continuation-in-Part of U.S. patent application Ser. No. 09/312,002, filed on May 14, 1999, for a Biometric System for Biometric Input, Comparison, Authentication and Access control and Method therefor, the contents of which are incorporated herein be reference.

### FIELD OF THE INVENTION

The present invention relates to a system for biometric authentification system for biometric input, comparison, and authentication and, more particularly, to a biometric authentification system and method capable of effectively detecting and utilizing a fingerprint image in a substantially small and compact sampling area so to provide substantially secure and accurate biometric access restriction. The system and method remove the need for a large fingerprint sampling so as to achieve a high degree of security and accuracy without a substantial incidence of authentication denials based upon actually authorized biometric inputs, thereby expanding the useability of advanced biometric sampling systems.

### DESCRIPTION OF THE RELATED ART

Biometric input devices are becoming more widely used in a variety of fields due to an ever increasing desire for security in today's society. In particular, it is recognized that each individual has certain characteristic biometric identifiers which are unique to them, and can thereby provide a substantially accurate and controlled verification of the identity of an individual.

One of the most common types of biometric identifiers is a fingerprint identifier, wherein fingerprint image data is gathered by a biometric input device and compared with stored fingerprint image data. Specifically, fingerprint based biometric input devices generally achieve the necessary authentication by requiring that an individual place a finger on an appropriate scanning surface of a biometric input device, thereby permitting the generation of fingerprint image data. The fingerprint image data is then compared with a data base of one or more authorized fingerprint images in order to ensure proper identification.

While the unique nature of each person's fingerprint makes such biometric authentication procedures substantially effective to ensure a person's true identity, the complex nature of each person's fingerprint requires the undertaking of very detailed and complex verification procedures. In particular, although every individual's fingerprint is unique, and stays generally the same, based in part on the different manners or orientations in which the finger is scanned and/or small imperfection in the finger, the manner of comparison of a detected fingerprint with a fingerprint image stored in a data base can be a very complicated process if true accuracy is to be desired. Furthermore, it is also recognized that although it is totally unacceptable to have a false authentication, is also very undesirable to have a large occurrence of authentication denials despite the scanning of an authorized finger print. Accordingly, biometric input devices must achieve a certain balance between the security needs of ensuring that no unauthorized authentications are achieved, and the needs for practicality and useability, permitting rapid and accurate access when appropriate.

In order to achieve this desired balance between security and usability, known biometric input devices generally will utilize a sampling of preferably an entire finger surface so as to obtain the maximum finger print image data available for the finger print. This is done so that a large number of predefined characteristic points are present in the image data and can be utilized for comparison purposes. Unfortunately, however, such authentication systems, while generally being sufficiently accurate and effective, also require the utilization of a larger device and scanning surface to achieve the required image data, and often limit effective biometric readings to those taken from a person's thumb fingerprint, as it provides the largest surface area.

As a result, it would be highly beneficial to provide a biometric input device and method which is capable of being configured in a substantially compact fashion, utilizing a finger print from any of a person's fingers in order to achieve a substantially high degree of security, while still maintaining the practicality and usability of the overall device.

Indeed, it is recognized that in recent years a variety of alternate biometric scanning surfaces capable of detecting a person's finger print and generating fingerprint image data have been developed which depart from the traditional optical systems. While such new biometric detecting configurations may someday expand the possibilities for the overall configuration of the biometric input device, until the present invention, such expanded and effective uses had not yet been contemplated or even attempted because of the fundamental requirements of the comparison methods and therefore the need to detect a large finger print image capable of providing sufficient traditional characterizing points to achieve an accurate authentication comparison and minimize improper denials of authorized fingerprints.

Therefore, it would also be beneficial to provide an improved biometric input device which is configured to be more convenient and effective to utilize in a variety of different circumstances and configurations, and which in addition to its convenience of use, is also capable of providing a substantial degree of accuracy and usability under repeated and continuous use. Furthermore, it would be beneficial if such as a system, when associated with a computer system, be easy and convenient to integrate, minimizing any added encumbrances and/or steps to be performed by a user seeking authentification of their fingerprint.

Along these lines, traditional biometric input devices are known for use with computing systems. Such biometric input devices include computer mouse designs. Existing designs for such biometric input devices have scanning windows lacking efficient positioning structure for scanning positioning and protection from ambient light, in the case of an optical assembly, and do not provide mechanical integration of a position sensing ball assembly with an optical scanning assembly maximizing reliability of position sensing ball operation.

Likewise, biometric data comparison methods and systems utilizing the traditional comparison characteristics of a fingerprint are known. Such known systems and methods, however, suffer from various drawbacks including intensive computing power requirements, large image data requirements, intensive memory requirements, slow data transfer, slow comparison, and/or comparison reliability reduction due to environmental and physiological factors. Known systems also fail to provide for secure communication of biometric data over public lines.

### SUMMARY OF THE INVENTION

Briefly stated, the present invention provides a biometric input device, system and method which includes a biometric input device having a scanning window or other biometric scanning surface, which in one embodiment is surrounded by a ridge for ensuring positive positioning of a biometric sample such as a thumb. For example, one embodiment of the biometric input device includes an optical assembly as the biometric scanning surface, the optical assembly including a prism with a focusing lens disposed on a side thereof and optionally integrally formed therewith. Alternatively, however, the scanning surface may be comprised from a silicon and/or capacitance basis, a self-illuminating polymer film, a heat based sensor array, optical chip technology, and/or another type of scanning surface, all of which are capable of detecting and identifying biometric reference data corresponding a biometric identifier of a user, such as a fingerprint. Of course, it is recognized that the biometric identifier may include a fingerprint, voiceprint, retinal image, DNA sample and/or any other type biometric identifier which provides a substantial degree of uniqueness to an individual. Also, as will be described, a biometric comparison and/or authentification method is provided for comparing data from the biometric input device with data from a database using in one embodiment both directional image comparison and clusterized minutia location and direction comparison. A further system is provided for allowing access to computer functions base on the outcome of the comparison method.

In one illustrated embodiment, the biometric input device accepts a fingerprint of a finger tip having opposing tip sides and a tip end, and may include a device body having a body wall defining at least one aperture, and an optical assembly for scanning the fingerprint disposed on the device body. The optical assembly has a scanning surface at the aperture upon which the finger tip is placed for scanning of the fingerprint by the optical assembly. A ridge surrounds a portion of a periphery of the aperture such that the ridge engages the opposing tip sides and tip end such as to position the fingerprint on the scanning surface and block ambient light.

A further feature of an embodiment of the present invention includes the aforesaid biometric input device having a device body with a bottom surface opposing a substrate upon which the device body is placed, a device body length and a front portion, a middle portion and a heel portion. A movement detection device for detecting movement of the device body relative the substrate is provided and the bottom surface defined a bottom surface aperture through which the movement detection device detects movement of the device body relative the substrate. The bottom surface aperture is disposed in the heel portion of the device body and the optical assembly is disposed in the middle portion of the device body. In such an embodiment of the present invention the movement detection device preferably has a ball protruding through the bottom surface aperture for engaging the substrate to register the movement of the device body relative the substrate.

According to a feature of the invention, there is further provided a biometric input device for accepting a fingerprint of a finger tip having opposing tip sides and a tip end, and may comprise a device body having a body side wall defining an aperture, and in one embodiment an optical assembly for scanning the fingerprint disposed in the device body. The optical assembly includes an imaging component for converting a light image into a pixel output and a lens for focusing the light image into the imaging component. The optical assembly includes a prism with first, second and third sides and a top side wherein the first side forms a scanning surface at the aperture upon which the finger tip is placed for scanning of the fingerprint by the optical assembly, the second side has the lens for focusing the light image into the imaging component disposed thereon, and the third side has a light absorbing layer. In the alternative or in combination with one another, the lens may be formed integrally with the prism and a light emitting device is disposed to emit light into the prism from the top side of the prism to illuminate the fingerprint when disposed at the scanning surface. Of course, as will be described in greater detail subsequently, alternate scanning surfaces which may or may not utilize an optical assembly may also be utilized in alternate embodiments of the present invention.

According to a still further feature of the invention, there is provided a biometric comparison method comprising a series of steps beginning with (a) scanning in a fingerprint and digitizing the scanning signals to produce a matrix of print image data representing pixels. Next the method proceeds with (b) dividing the print image data into cells, each including a number of pixel data for contiguous pixels, and (c) calculating a matrix of directional image data DI using gradient statistics applied to the cells wherein the directional image data DI includes, for each of the cells, a cell position indicator and one of a cell vector indicative of a direction of ridge lines and an unidirectional flag indicative of a nondirectional calculation result. Processing then continues with (d) skeletonizing the print image data, and (e) extracting characteristic points, and preferably minutia points from the print image data and producing a minutia data set comprised of data triplets for each minutia extracted, including minutia position data and minutia direction data.

Next, a comparing process is initiated by (f) providing reference fingerprint data from a database wherein the reference fingerprint data includes reference directional image data DI and a reference minutia data set, and (g) performing successive comparisons of the directional image data DI with the reference directional image data DI and determining a directional difference DifDI for each of the successive comparisons wherein for each of the successive comparisons one of the directional image data DI and the reference directional image data DI is positionally shifted by adding position shift data. In a next step (h) it is determined for which of the successive comparisons the directional difference DifDI is the least and the position shift data thereof is selected as initial minutia shift data. A next stage of the comparison process proceeds with (i) positional shifting minutia data by applying the initial minutia shift data to one of the minutia data sets and the reference minutia data set to initially positionally shift the minutia position data and the minutia orientation data, then (j) performing successive comparisons of the minutia data set with the reference minutia data set following the positional shifting minutia data and determining matching minutia based on a minutia distance criteria, a number of matching minutia, and a similarity measure indicative of correspondence of the matching minutia for each of the successive comparisons wherein, for each of the successive comparisons, one of the minutia data sets and the reference minutia data set is positional shifted within a minutia shift range R by adding minutia position shift data, and finally (k) determining a maximum similarity measure of the similarity measures of the successive comparisons. The comparison method concludes with (1) determining whether the maximum similarity measure is above a similarity threshold and indicating the reference fingerprint data and the fingerprint data are from the same fingerprint when the maximum similarity measure is above the similarity threshold.

The present invention also includes the above method wherein, as an alternative, the calculation of the directional image data includes (c1) identifying a directional group of cells comprising all cells of the cells that do not have the unidirectional flag associated therewith; and then excluding from the successive comparisons of minutia data sets, one of the minutia data sets and the reference minutia data set located in or positionally aligned with the cells that have the unidirectional flag associated therewith.

The present invention further provides a feature for use in conducting the successive comparisons of minutia points comprising dividing the minutia data set into the minutia data set clusters formed on contiguous one the cells and each including a predetermined number of the minutia before conducting the successive comparisons, conducting the successive comparisons for each of the minutia data set clusters and determining for each of the minutia data set clusters a maximum similarity measure, and finally determining the maximum similarity measure as a sum of the maximum similarity measures of each of the minutia data set clusters.

The present invention also provides for the above comparison method excluding from further processing pairs of the minutia located within a minutia exclusion distance of one another and having minutia direction data with a direction exclusion limit being in opposite directions.

The present invention further provides a feature wherein in the above comparison method the minutia extraction step extracts minutia points limited to ends and bifurcations. Still further there is provided a feature wherein the minutia data set excludes data distinguishing ends and bifurcations. Also, in some instances wherein the available minutia is limited and may not provide a sufficiently accurate verification or authentification, the present invention integrates the generation and utilization of pseudo minutia points from the connecting patterns between two or more of the available minutia points. Accordingly, sufficient accuracy and verifiability can be achieved for a wide range of fingerprint samplings and utilizing a variety of fingerprint image generating systems.

Preferably, but not necessarily, utilizing the aforementioned method and system for identifying and calculating minutia data, and/or the aforementioned biometric input device and system, the present invention is further directed towards a method of analyzing a fingerprint and/or other biometric identifier. In particular, once fingerprint image data is collected and/or detected, the minutia therefor is identified. From this minutia gathered at least two, but preferably a plurality of minutia points are identified. In order to effectuate accurate and secure authentification security, a large number of minutia points are preferably utilized for comparison, such as utilizing the aforementioned method. Because, however, in some cases, and especially utilizing certain types of biometric input devices and scanning surfaces a less than ideal number of minutia points are available for comparison purposes, an embodiment of the present invention further comprises the step of identifying a connection pattern between at least two of the available minutia points. This connecting pattern is then utilized to define one or more additional comparison characteristics for the biometric identifier, such as the fingerprint, thereby providing a sufficient number of comparison characteristics to achieve a desirable degree of security and reliability.

Along these lines, the present invention further comprises a biometric authentification system having a biometric input device, a biometric storage assembly and a biometric comparison assembly, all or some of which may be separate components and/or integrated into a single structure. Further, while the structures of the embodiments described herein may be examples of one or more components of the present authentification system, it is recognized that a variety of alternate input devices, storage assemblies and/or comparison assemblies may be equivalently utilized. Particularly in this embodiment, however, the biometric input device, and/or a biometric scanning surface thereof, may be substantially compact and therefore may detect and/or identify only a portion of the biometric identifier of a prospective user seeking authentification. In such a system, the biometric comparison system preferably utilizes the image data available and identifies the connection pattern between at least two, preferably adjacent, minutia points that form part of the minutia detected for comparison. Furthermore, that connecting pattern is preferably divided into a plurality of pseudo minutia points which thereafter also serve as comparison characteristics utilized by the biometric comparison assembly for authentification purposes. As a result, the biometric authentification system is generally ensured that sufficient comparison characteristics are available to achieve proper and functional authentification, such as, but not necessarily, utilizing the comparison algorithm and methods described herein.

Yet another feature of the present invention is a biometric comparison system comprising a computer having a memory including a reference fingerprint data and at least one of file data and application software, a display, an apparatus for representing at least one of file data and application software as icons on the display, and a biometric input device for scanning a fingerprint and storing fingerprint data representing the fingerprint into the memory. A comparison engine is provided for comparing the fingerprint data with the reference fingerprint data and determining a match if a similarity threshold is satisfied. An access control icon generator permits a user to move an access control icon on the display and an access control means is provided for controlling access to the at least one of file data and application software when a user moves the access control icon onto the icon representing the at least one of file data application software whereby access to the at least one of file data and application software is permitted only if a user scans a fingerprint producing fingerprint data for which the comparison means determines matches the reference fingerprint data.

The above and features and advantages of the present invention will become apparent from the following description read in conjunction with the accompanying drawings, in which like reference numerals designate the same elements.

### BRIEF DESCRIPTION OF THE DRAWINGS

For a fuller understanding of the nature of the present invention, reference should be had to the following detailed description taken in connection with the accompanying drawings in which:

FIG. 1a is a block diagram of a system of the present invention;

FIG. 1b is a block diagram of an alternative system of the present invention;

FIG. 2a is a top plan simplified view of a biometric input device of the present invention;

FIG. 2b is a side elevation view of the biometric input device of FIGS. 2a showing internal components in dashed lines;

FIG. 3a is a side elevation view of the biometric input device of FIG. 2a showing surface contours;

FIG. 3b is a bottom perspective view of the biometric input device of FIG. 2a showing surface contours and dimensional disposition of features;

FIG. 4 is a block schematic of the biometric input device of FIG. 2a;

FIG. 5 is a flow chart for operation of the biometric input device of FIG. 2a;

FIG. 6 is a flow chart of the comparison method of the present invention;

FIG. 7 is an illustration of a directional image analysis;

FIG. 8(a) is an image of the fingerprint based on data received from an optical scanning assembly;

FIG. 8(b) is an image of the fingerprint of FIG. 8(a) following low pass filtering;

FIG. 8(c) is an image of the fingerprint of FIG. 8(a) following directional filtering and binarization;

FIG. 8(d) is an image of the fingerprint of FIG. 8(a) following skeletonization;

FIG. 9(a) is a depiction of a bifurcation;

FIG. 9(b) is a depiction of an end;

FIG. 10 is a depiction of an analysis of two minutia exclusion purposes;

FIG. 11 is a simplified depiction of a fingerprint image data FP1 divided into clusters;

FIG. 12 is a simplified depiction of the clusters of FIG. 11 applied individually shift to print image data FP2;

FIG. 13 is a top illustration of another embodiment of a biometric input device which may be utilized within the system and method of the present invention; and

FIG. 14 is a depiction of a fingerprint image and corresponding minutia points between which a connecting pattern, and accordingly pseudo minutia points may be defined.

Like reference numerals refer to like parts throughout the several views of the drawings.

### DETAILED DESCRIPTION OF THE PREFERRED EMBODIMENT

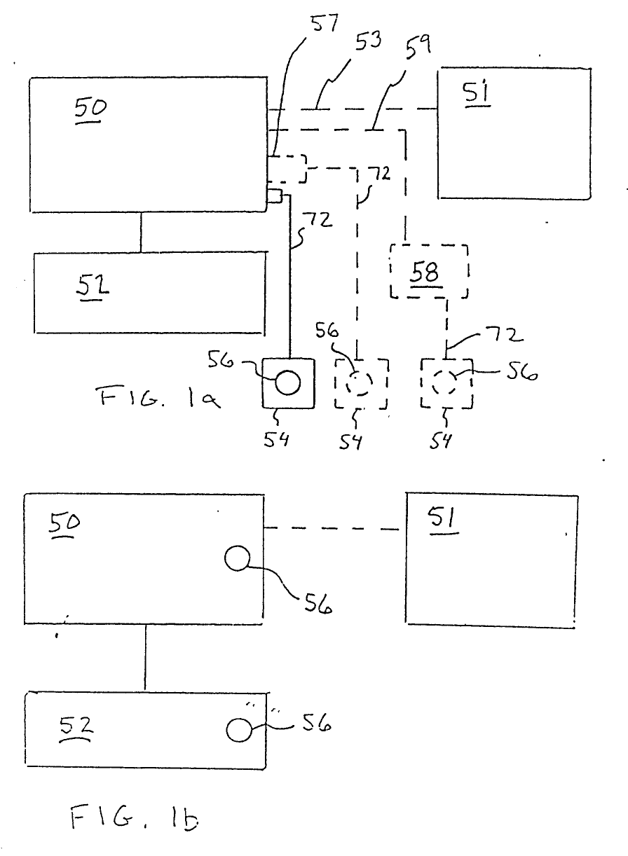

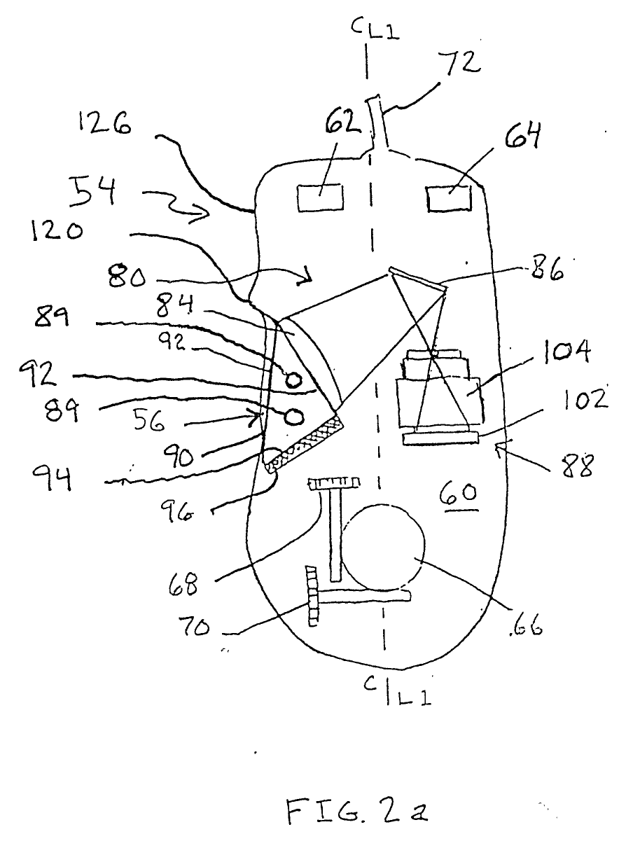

Referring to FIG. 1A, in one embodiment of the present invention a computer 50 has a keyboard 52 and a biometric input device 54 with a scanning window 56 for accepting biometric input. The computer 50 may take the form of a personal computer, a dedicated device such as an ATM machine, a dumb terminal, or a computer on the order of a workstation, minicomputer, programmable chip or mainframe. Optionally, the computer 50 may be connected to a remote computer 51 via a link 53 which may be a direct link via phone lines or direct cabling, or via a network such as a LAN, WAN, intranet or Internet. In order to gain access to use of the computer 50, or remote computer 51, for all or only specified functions, a user must provide a biometric input to the biometric input device 54 via 14 the scanning window 56. Hereinafter the computer 50 will be referred to, however, it is understood that the remote computer 51 may optionally perform the functions ascribed to the computer 50 with the computer 50 functioning as a terminal and/or being an independent device. Likewise, reference to gaining access to use of the computer 50 is understood to include the alternative of access to use of the remote computer 51.

The computer 50 compares biometric data, representing the biometric input, with stored biometric data and determines if the biometric data corresponds to any stored biometric data held in a data base. If a correspondence exists, the user is given authorization, that is, the user is allowed access to the computer 50 for performance of the specified functions or for use of the computer 50 in general.

The biometric input device 54 is connected to the computer 50 via an input cord 72. Alternatively, depending upon the type of port the biometric input device 54 uses to communicate with the computer 50, an embodiment of the present invention has a port adaptor connector 57 connecting the input cord 72 to a corresponding port on the computer 50. A still further alternative provides an embodiment of the present invention wherein a stand-alone adaptor unit 58 channels data via the input cord 72 and a cable 59 to and from the computer 50. Moreover, if desired, an infra red or other remote and/or wireless data communication structure could be provided.

Referring to FIG. 1B, one configuration is shown wherein the scanning window 56 and associated structure is incorporated in either the computer 50 or the keyboard 52. In such instances, the stand-alone biometric input device 54 is omitted and functions thereof are performed by the computer 50 or by circuitry incorporated in the keyboard 52. It is understood that functions discussed herein with respect to the biometric input device 54 and the computer 50 may optionally be distributed between the biometric input device 54 and the computer 50 as is practical.

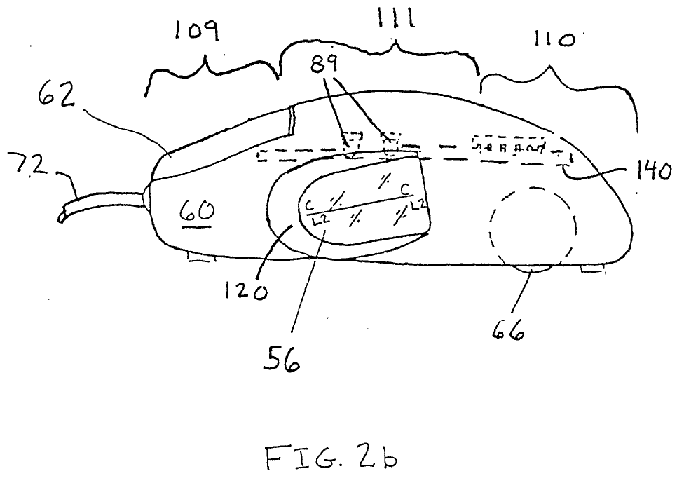

Referring to FIGS. 2A and 2B, the biometric input device 54 is shown in the form of a computer mouse 60. Alternatively, the biometric input device may take the form of another type of input device such as a track ball, joystick, touch pad, pen or other variety of input device. The computer mouse 60 preferably includes a left button 62, a right button 64, a ball 66, an X direction sensor 68, and a Y direction sensor 70. Various means may be used to effect input from these devices including mechanical, optical or other. For example, optical means may be substituted for the ball 66 to detect mouse movement. The input cord 72 connects to the computer 50 for effecting data transfer. Optionally, the input cord 72 is replaced by wireless means for effecting data transfer which operate using optical or electromagnetic transmission.

The present invention further includes in one embodiment an optical assembly 80 to define a scanning surface to obtain image data. The optical assembly 80 preferably includes a prism 82, a first lens 84, a mirror 86, a CCD assembly 88, and LED's 89. In particular, the prism 82 has first, second and third sides, 90, 92 and 94, respectively. The first side 90 generally defines the surface of the scanning window 56. Moreover, a coating(s) or a transparent plate may optionally be used to protect the first side 90. The second side 92 preferably includes the first lens 84 disposed thereon or formed integrally with the prism 82. Preferably, the prism 82 is molded integrally with the first lens 84 which provides for reducing part count and simplifying the assembly of the biometric input device 54. The third side 94 includes a light absorbing coating 96.

The CCD assembly 88 includes a CCD sensor 102 and a second lens 104 which functions as an object lens. The first and second lenses 84 and 104 preferably function in conjunction with the mirror 86, as shown by light ray tracings, to focus an image at the first surface 90 onto the CCD sensor 102. Various other lens assemblies and configurations may optionally be realized by those of ordinary skill in the art and are considered to be within the scope and spirit of the present invention.

In order to input biometric data, a user holds the computer mouse 60 with the index, middle or third finger preferably extended to operate the left and right buttons, 62 and 64, and with the thumb contacting the scanning window 56 to permit an image of a thumb print to be focussed onto the CCD sensor 102. The user then operates any of the left and right buttons, 62 or 64, or other input device, to initiate scanning of the thumb print. Alternatively, scanning may be automatically initiated by circuitry in the biometric input device 54 or the computer 50.

The structural configuration of an embodiment of the computer mouse 60 is detailed below wherein a front portion 109 of the computer mouse 60 generally refers to an end portion of the computer mouse 60 from where the input cord 72 preferably extends and where the left and right buttons, 62 and 64, are situated, a heel portion 110 which comprises a rear end portion where a user's palm typically rests, and a middle portion 111 which is an area where the balls of the user's hand typically are situated. The front portion 109, the heel portion 110, and the middle portion 111 are situated to define three sections of a length L of the computer mouse 60 extending from a front end of the end portion 109 to a rear end of the heel portion 110.

The scanning window 56 of the previously described scanning surface configuration is preferably situated generally on a side of the middle portion 111 and preferably has a ridge 120 framing at least three sides of the scanning window 56. The ridge 120 is configured to accept a perimeter of a user's thumb, thereby defining a scanning position of the user's thumb in the scanning window 56. Furthermore, the ridge 120 serves to shield the scanning window 56 from ambient light during the scanning process and also to protect the scanning window 56 from damage.

The ball 66 is preferably disposed with a center thereof within the heel portion 110 of the computer mouse 60. Such disposition of the ball 66 provides advantageous situation of the ball 66 under the palm of the user's hand so that pressure from the palm during operation ensures positive contact of the ball 66 with a substrate upon which the computer mouse 60 is used. The ball 66 is optionally disposed rearward of a mid-position in the computer mouse 60 wherein the mid-position is a middle of the length L of the computer mouse 60. In conventional configurations the ball 66 is situated either in the middle portion, forward of the mid-position in the computer mouse, or in the front portion. Such a construction is prone to intermittent contact of the ball with the substrate due to the user applying excessive downward force to the heel portion of the mouse resulting in the front and middle portions rising from the substrate.

A circuit board 140 contains circuitry for effecting scanning operation of the optical assembly 80. As an alternative to the optical assembly 80, a contact detection assembly may be realized wherein the scanning window 56 takes the form of a silicon contact sensor. In either configuration, a thumb print of the user is represented by data of an array of pixels. The LED's 89 are mounted on the circuit board 140 in a position above a top surface of the prism 82 to radiate light into the prism 82 for scanning the thumb print. The embodiment shown has two LED's, but it is realized a single LED may be used or alternative light generating devices may be substituted therefor. Furthermore, although the embodiment shown provides the LED's 89 mounted on the circuit board 140, the LED's 89 may alternatively be mounted on the prism 82 or molded into the prism 82, at the top side, in the same operation wherein the first lens 84 is molded integrally with the prism 82.

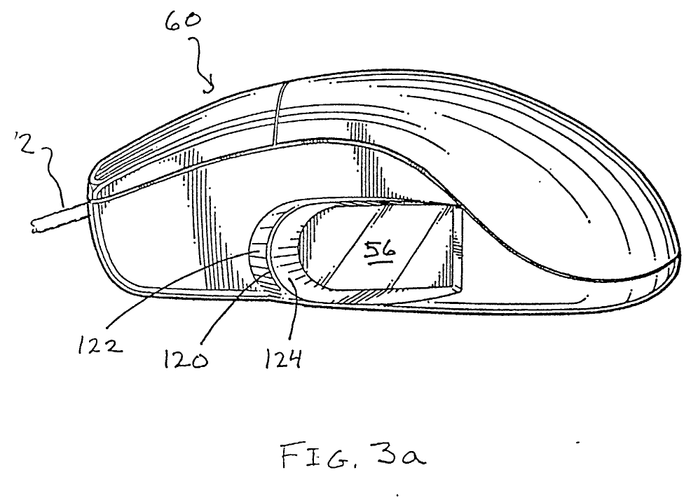

Referring to FIGS. 3A and 3B, perspective depictions of the computer mouse 60 illustrate the length L of the computer mouse 60, the disposition of the ball 66 and the structure of the ridge 120. The ridge 120 has an outer surface 122 extending outwardly from a side surface 126 of the computer mouse 60 and an inner surface 124 extending from a peak of the ridge structure to the scanning surface 56. The ridge 120 is raised from the side surface 126 preferably on at least three sides of the scanning window 56, that is, front, top and bottom sides. On a fourth or rear side, a rise of the ridge 120 from the side surface 126 is optionally omitted to permit ease of insertion of the thumb against the scanning window 56. The location of the ridge 120 on the three sides of the scanning window 56 ensures positive location of the thumb for scanning purposes to minimize scan to scan variations in positioning of the thumb print thereby facilitating thumb print comparisons. The center of the ball 66 is shown rearward of the mid-position, the middle portion 111 which includes the middle section of the computer mouse 60, and the three quarter length position. The outer surface 122 is concave but may optionally be flat or convex. Likewise, the inner surface 124 is concave but may optionally be flat or convex. Furthermore, the outer surface 122 may be omitted with the inner surface 124 serving alone to position the thumb wherein the inner surface 124 defines a recess in the side surface 126. However, the rising of the outer surface 122 from the side surface 124 provides for the side surface 126 protruding less outwardly from a mouse body centerline CL1 of the computer mouse 60, shown in FIG. 2a, thereby providing for a functionally less cumbersome device.

Referring again to FIG. 2a, a surface of the scanning window 56 is preferably inclined with respect to the mouse body centerline CL1 to define an acute angle with respect thereto in the range of 5° to 25°, and preferably in the range of 10° to 20°. A front edge of the scanning surface 56 is recessed inwardly toward the mouse body centerline CL1 from a position of the side wall 126 relative to the mouse body centerline CL1. Such positioning provides for an ergonomically advantageous positioning of the thumb when the computer mouse 60 is held. In one embodiment of the invention the scanning window 56 has a length of about 30 mm and a width of about 18 mm.

Referring again to FIG. 2b, the scanning window 56 is inclined in the vertical plane with respect to the substrate upon which the computer mouse 60 rests such that a longitudinal center line CL2 of the scanning surface defines an acute angle with respect to the substrate in the range of 0° to 25°, and preferably in the range of 5° to 15°. Such positioning provides for a further ergonomically advantageous positioning of the thumb when the computer mouse 60 is held.

The prism 82 is a right angle prism with a forward acute angle in the range of 40° to 60° and preferably in the range of 45° to 55°. The mirror 86 serves to redirect light to the CCD assembly 88 thereby providing for a compact arrangement of the optical assembly 80. In one embodiment the forward angle is about 50°.

Referring to FIG. 4, an embodiment of circuitry provided on board 140 is shown. A microcontroller 150 is preferably interfaced with a CCD controller 152, a ROM 154, a RAM 156, and an A/D converter 158. Output from the CCD sensor 102 is input to the A/D converter 158 where it is digitized. The CCD controller 152 effects scanning of the CCD sensor 102 to transfer sensed levels of the pixels of the CCD sensor 102. The microcontroller 150 further controls the intensity of light produced by the LED 89. An interface controller 160 is interfaced with the microcontroller 150 to effect communication with a serial port of the computer 50. Other interfaces may be employed permitting data communication with the computer 50. Furthermore, the microcontroller 150 may optionally receive mouse input from the left and right mouse buttons, 62 and 64, and the x and y sensors, 68 and 70, and transmit the mouse input to the computer 50 to effect combined functions of thumb print scanning and mouse control.

The microcontroller 150 is optionally in the form of a programmable logic device (PLD). One such device is the FLEX10K from Altera. The microcontroller 150 controls the CCD controller 152, determines a size and position of a frame, records image data of the frame into the RAM 156, and supports communication protocol with the interface controller 160, such as the RS-232 interface, the PS-2 interface, or the USB interface.

The ROM 154 stores program codes for the microcontroller 150 and may be programmed to effect operations over various interfaces. While discrete IC's are shown, it is realized that the functions of the IC's may be integrated in a single IC. The CCD controller 152 effects reading of successive pixels and lines of the CCD sensor 102. A matrix of data from the pixel array of the CCD sensor 102 forms the frame and is stored in the RAM 156. The frame consists of data representative of the thumb print image and preferably excludes data from pixels not representative of the thumb print image. Thus, the frame represents a subset of data from a complete scanning of the CCD sensor 102. Accordingly, the amount of data to be processed and sent to the computer 50 is optionally reduced from that of an entire scan of the CCD sensor 102.

In an embodiment of the invention, the interface controller 160 may be incorporated into an interface unit 162 for connecting the input cord 72 to the computer to permit operation over various interfaces by substitution of the interface unit 162 having the desired interface controller 160. The interface unit 162 may be in a separate housing connectable to a desired input port, as shown in FIG. 1a as the stand-alone adapter unit 58, or a connector housing itself as show in FIG. 1a as the port adapter connector 57. Implementation of the interface unit 162 is dictated by the type of port to be interfaced.

A parallel printer port interface (LPT), that is, a PS2 port interface, may be effected using a microcontroller and a PLD, for example, a ZILOG Corp. Z86E02 in conjunction with a FLEX8K PLD from Altera Corp. In such instance the interface connector 162 is a separate housing which is connected to the computer's printer port with a cable and has a connector for the input cord 72 and for a parallel printer cable through which a printer may be interfaced to the computer 50. Power is supplied to the interface connector 162 and the computer mouse 60 via the PS2 port from the computer 50. Data exchange for the computer mouse's 50 usual mouse input, that is, input from the left and right buttons, 62 and 64, and the x and y sensors, 69 and 70, is preferably effected using standard protocol for PS2 mouse interface and the PLD based on output from the microcontroller 150 of the computer mouse 60.

A full speed USB interface at 12 MBaud may be effected using a processor in the interface unit 162, such as an Intel Corp. 930, which has in built USB functions. In such an instance the interface unit 162 is optionally a separate housing in the form of a stand-alone adapter unit 58 which is connected to the computer's USB port with a cable 59, as shown in FIG. 1a, and has a connector for the input cord 72. Power is supplied from the computer 50 for the interface unit 162 and the computer mouse 60 via the USB port.

A serial port interface, that is, a COM port interface, functioning at 115.2 KB may be effected using a processor in the interface unit 162, such as an Atmel AT29C2051, and an RS232 voltage converter. In such an instance the interface unit 162 is optionally incorporated in a connector for connecting the input cord 72 to the computer's 50 serial port. Power is supplied from the computer 50 via a further connector and is processed by the voltage converter to drive the computer mouse 50.

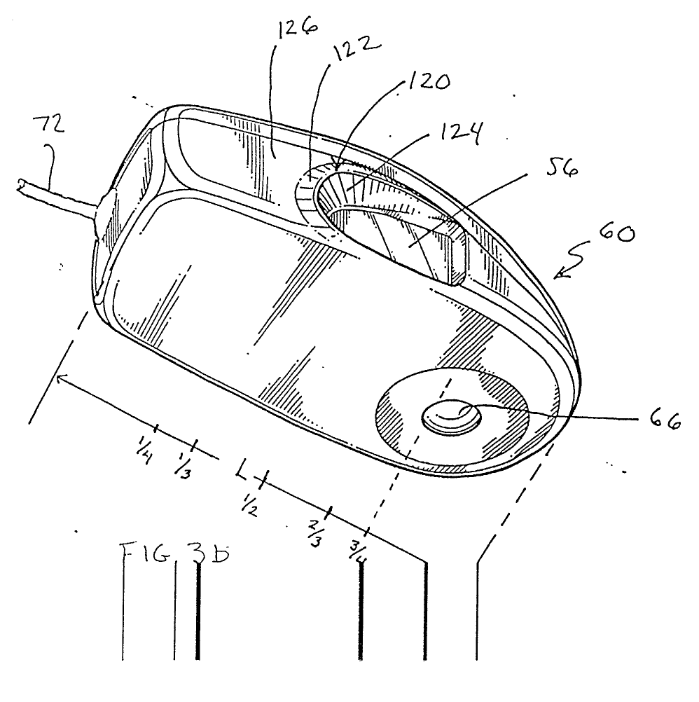

Referring to FIG. 5, a flow chart is shown of operation of the computer mouse 60. Operation begins at an start point 200 and proceeds to decision step 205 to determine whether a read print command is received from the computer 50, referred to as “PC” in the flow chart, to read in a thumb print. If a “read print” command is received, the LED 89 is lit to a maximum level in step 210. Next, in step 215, data from the CCD sensor 102 is read. Following reading CCD data, a decision step 220 is executed to determine whether a finger is detected. When a finger is detected operation proceeds to a decision step 225 to determine whether the light level is acceptable, and if it is not the level is adjusted and operation returns to step 215. If the light level is acceptable, operation proceeds to transmission step 230 wherein a message is sent to the computer 50 indicating that print data is to be sent. In another transmission step 235 a line of print data from the CCD sensor 102 is sent to the computer 50.

Operation then proceeds to a decision step 240 wherein it is determined whether the end of the image data has been sent to the computer 50. If transmission of the image data is not complete, a check is made in a status verification step 245 to see whether there is any mouse input, such as data from any of the left button 62, right button 64, X sensor 68, or Y sensor 70 input by the user and, if such data has been input, it is sent to the computer 50 in a transmission step 250. Operation returns to the transmission step 235 wherein a next line of CCD data is sent to the computer 50 after the mouse input is sent to the computer 60 or if no mouse input is detected. If it is determined in the decision step 240 that transmission of image data is complete, operation returns to the beginning of the flow chart below the start step 200.

In step 205, if no read print command is received, operation proceeds to a status verification step 255 to see whether any mouse input has been inputted by the user and, if such data has been inputted, it is sent to the computer 50 in transmission step 260.

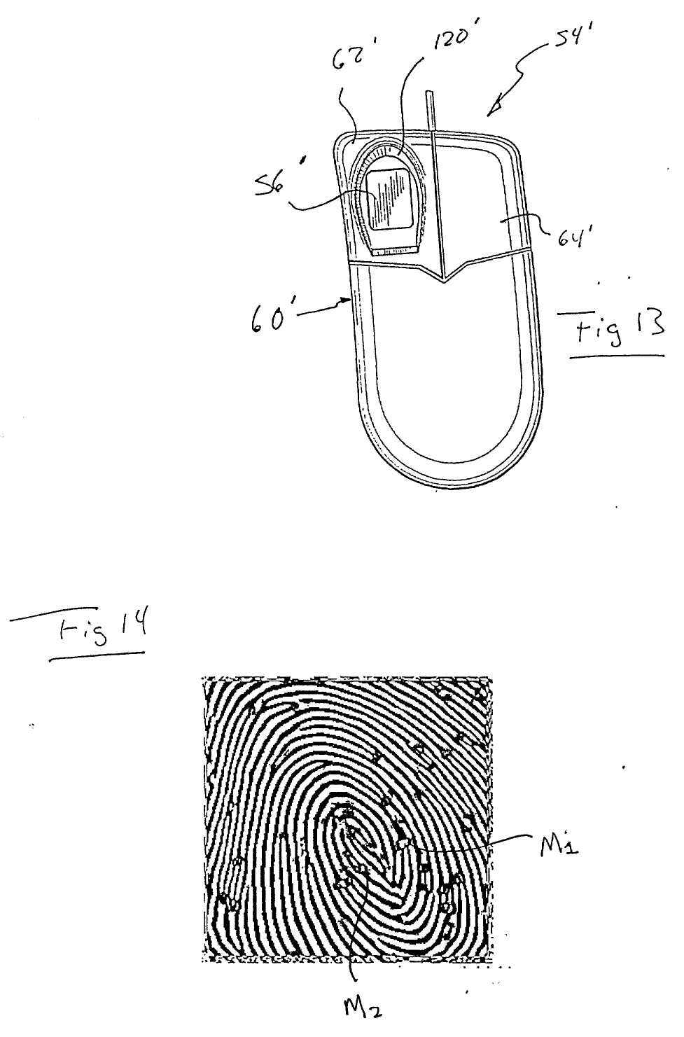

Turning to FIG. 13, in yet another embodiment of the present biometric input device 54′, the scanning surface 56′ is preferably disposed directly within one or more of the buttons 62′ or 64′ of a mouse 60′. In such an embodiment, the scanning surface 56′ is preferably substantially compact so as to fit within the confines of a corresponding button 62′, 64′ of the mouse 60′, and as a result may include a scanning surface with a silicon and/or capacitance basis, a self-illuminating polymer film, a heat based sensor array, optical chip technology and/or another developed or to be developed type of scanning surface. Moreover, such alternate types of scanning surface 56′ may be preferred to an optical type scanner, as previously recited, as conveyance of a scanned fingerprint data image can be more readily conveyed through an operative mouse button 62′, 64′ and into the body of the mouse 60′ for processing, and a clear and/or open optical path is not needed. Of course, such an alternate scanning surface could be utilized at a side of the mouse with the previously recited structure. Additionally, the configuration of the embodiment of FIG. 13 provides a more effective orientation of the scanning surface 56′, as users are accustomed to placing one or more fingers, and especially their index finger, on a corresponding mouse button 62′, 64′ at all times during use, and during selection. Accordingly, such positioning eliminates the need for the user to perform a separate step to position a thumb or other finger on a dedicated scanning area. Furthermore, with such a configuration, the biometric authentification can be integrated directly with the making of a selection, which has biometric access restriction, utilizing the mouse 60′. In particular, the depression of the button 62′, 64′ can be used to initiate the authentication process, and sufficient pressure on the scanning surface 56′ is always ensured as the user will be pushing down on the button to achieve actuation. In such an embodiment, the scanned image data is conveyed for processing, either within the biometric input device 54′ itself, or in an associated computer processor, utilizing conventional means, such as those described herein. It is noted that one or more scanning surfaces 56′ could be included within a left, right or center button of the mouse, and/or may be independently provided at a separate portion of the mouse.

Also preferably provided in the embodiment of FIG. 13 is a guide ridge 120′ on the corresponding mouse button 62′, 64′. The guide ridge 120′ functions to properly position and align a user's finger on the scanning surface 56′, which is especially beneficial if the scanning surface 56′ comprises less than the entire surface of button 62′ 64′ to be pressed.

As will be described in greater detail subsequently with reference to the biometric comparison system, the biometric input device 54′ of the embodiment of FIG. 13 may include a scanning surface that is smaller than traditionally utilized. The reduced configuration is provided, in part, because of the smaller size of the finger intended to be scanned, and so that the scanning surface 56′ can be effectively accommodated in a mouse button 62′, 64′. As such, in such a configuration, and even if a larger scanning surface is utilized, but only an index finger with a smaller fingerprint area is utilized, sufficient fingerprint data points may not necessarily be scanned to achieve authentification utilizing some authentification protocols. For this reason, the alternate comparison and authentification system to be described subsequently may be preferred for use, at least on demand, thereby ensuring that proper security is maintained, while allowing for a compact and effective configuration for the scanning surface 56′ and biometric input device 54′, whether in a mouse 60′ or another small article.

Once a complete set of image, or print data, is sent to and/or gathered by the computer 50, the computer 50 then proceeds to process the data. In the present description, image data is also referred to as print data in reference to the input of a thumb print. However, it is realized that other types of biometric input may be used and that the present invention may optionally used to process such other data. Examples of such other data include a print image of any of the other digits or images of other unique biometric data such as retinal images. Thus, such applications are considered to be within the scope and spirit of the present invention. Indeed, the entire operation of the present invention can be contained within the mouse itself, with only an authorization and/or restriction command being passed on to the computer itself.

After the thumb print image is scanned in and the image data thereof transferred to the computer 50, the image data is then processed and added to a database of print image data or used to gain access to use of the computer 50 by comparison to previously stored print image data in the database. Hereinafter, using image data to gain access is referred to as an authorization process while entering print image data into the database is referred to as a registration process.

Finger print image analysis may effect comparison of images. Alternatively, the present invention further provides an analysis algorithm that effects comparison of special point maps which indicate where special points, also known as minutia, of a fingerprint are located. The fingerprint analysis algorithm considers a fingerprint not as a determined object but as a stochastic object. There is a philosophical analogy, like the Laplas's determinism and the stochastic picture of the world. Another analogy is that the first practically significant results in speech recognition appeared as soon as the first stochastic models of human's speech had appeared. A discussion of standard approaches is found in the paper A real-time matching system for large fingerprint databases, N. K. Ratha, K. Karu, S. Chen, and A. K. Jain, IEEE Trans. on PAMI, August 1996, vol. 18, no. 8, pp. 799-813, which is incorporated herein by reference for its teaching relating to fingerprint analysis and modeling.

Factors that randomize print image data include elasticity of skin, humidity, level of impurity, skin temperature, individual characteristics of the user's finger-touch, among many other factors. The basic generation of a special points map optionally includes multiple finger touches of the same finger, that is, a user's thumb print is optionally scanned multiple times. Each image data from each scanning is referred to herein as a “standard.” The greater the number standards of a user stored in the database, the higher the reliability of the recognition is. The shorter the process of studying multiple standards, the less the reliability of recognition is.

Applicants have conducted experiments showing that the reliability of recognition and the quantity of the standards exhibit the following relationship:

| Quantity of Standards | Reliability |
|---|---|
| 1 | 89% |
| 3 | 92% |
| 5 | 95% |
| 7 | 98% |
| 12 | 99.5% |
| 20 | 99.9% |

The term “reliability,” as used above, relates a probability of recognizing a registered user, that is, matching a user's thumb print data with thumb print data in the data base after one touch.

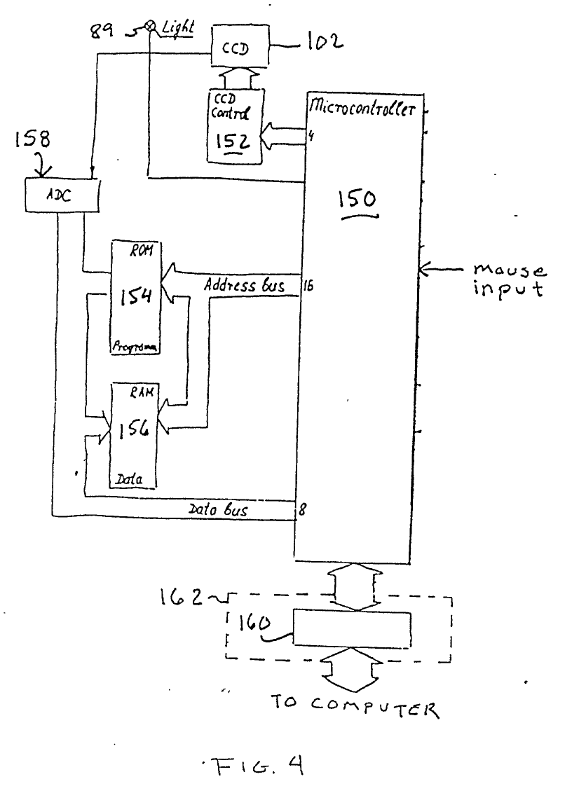

Referring to FIG. 6, a flow chart of a fingerprint analyzing algorithm of the present invention is shown. The algorithm is described below wherein the following definitions apply:

| VARIABLE | DEFINITION |
|---|---|
| Xn(i), Yn(i), An(i) | i-th minutia description wherein |
| | Xn is an x coordinate of the i-th |
| | minutia, Yn is a y coordinate of |
| | the i-th minutia, and An is an |
| | angle of the i-th minutia |
| FP | fingerprint |
| N | number of minutia of fingerprint |
| | after extraction |
| FPn | n-th fingerprint |
| MID | mean inter-ridge distance |
| DI | directional image |
| Xmas, Ymax | linear sizes of an input image |
| Fx, Fy | linear sizes (numbers of cells) in |
| | directional image, |
| Fstepx - Ymax/Fy | linear sizes of cells onto which |
| | the initial image is distributed |
| | to get directional image |
| Fn (i,j) | directional image for n-th |
| | fingerprint |
| Pi | discrete upper bound for 180 |
| | degrees |
| BI | number of cells of directional |
| | image that are not UnDir |
| UnDir (>Pi) | mask value to detect the absence |
| | of FP in a current cell, for n-th |
| | FP |

In imaging step 300, the user's thumb print is scanned by the CCD sensor 102 and then digitized at step 305, wherein analog levels for each pixel of the CCD sensor 102 are digitized to form one byte per pixel. Although depicted as separate operations, it is understood from the schematic of FIG. 4 that the analog levels of the pixels are successively digitized by the A/D converter 158 and stored in the RAM 156. Next, a sequence of filtering and contrasting transformations is executed on the initial matrix of intensity data. The aim is to get the more “stable” image of the fingerprint (while touching) Following storage in the RAM 158, the print image data FP is optionally transferred to the computer 50 as indicated in FIG. 5. However, in an alternative embodiment of the invention the filtering and contrasting transformations may be executed by the microcontroller 150 in the computer mouse 60 or other article.

The matrix of intensity data from the CCD sensor 102, that is, the print image data FP, includes the fingerprint and surrounding “garbage”. In an optional process a border between the print image and the “garbage” is defined and the “garbage” is excluded so that only the internal part of the print image, that is the portion which includes ridge lines, takes part in the further analysis.

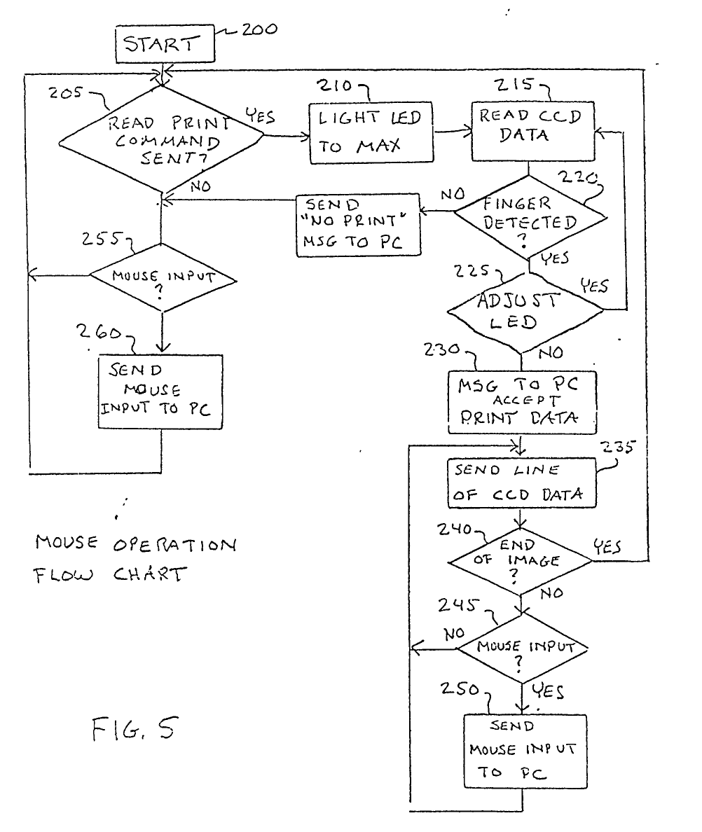

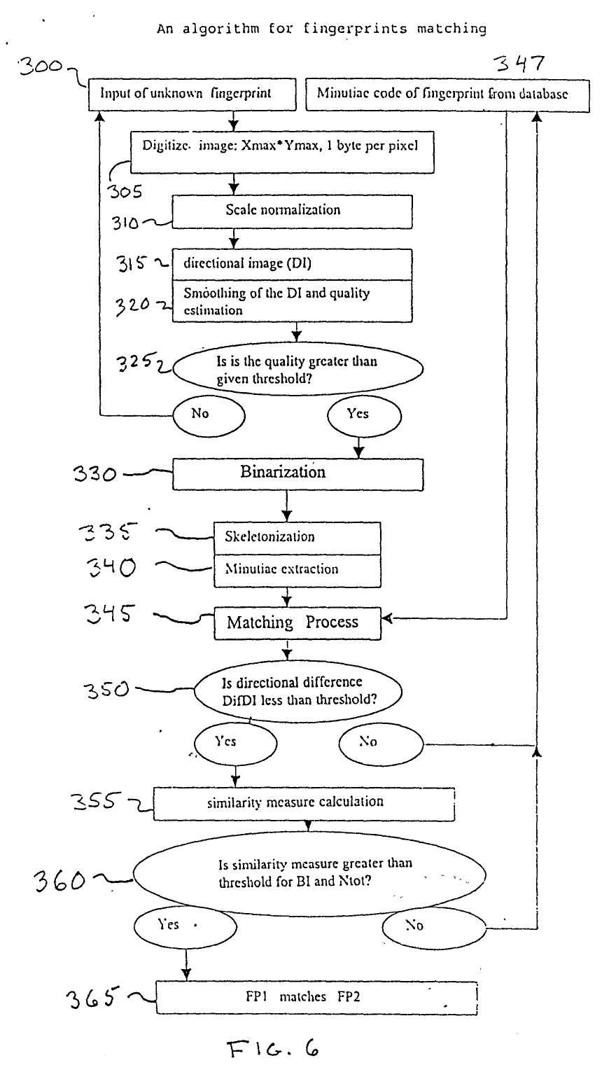

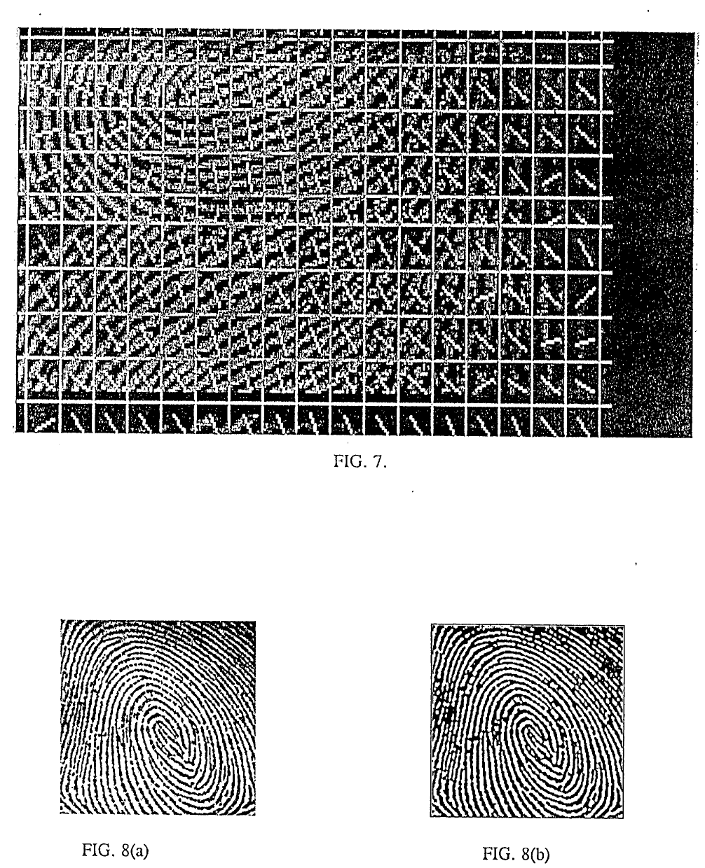

After the print image data FP is acquired, preprocessing of the print image data FP is carried out beginning with a scale normalization step 310 in which the scale of the print image data FP is normalized using standard routines. After the scale normalization step 310 the print image data FP is then used to calculate directional image data DI using gradient statistics in directional calculation step 315, wherein the print image is divided into cells having a size defined by Fx and Fy. Referring to FIG. 7, the print image data FP is divided into cells as shown by a grid superimposed on the print image and a vector normal to the direction of ridge lines in each cell is calculated. These vectors form the directional image data DI. Thus, an array of directional image data F(i,j) is generated where i and j denote the cell and the value of F(i,j) is between O and Pi for directional cells or is set to UnDir for cells wherein a directional gradient cannot be determined such as for isolated pixels or pixel groups lacking directionality. The directional image data DI is then subjected to a smoothing process and its quality factor Q is determined in a smoothing and quality processing step 320. The smoothing process includes first applying a low-pass filter and then a low-cut filter, after which a directional smoothing along the directions defined for each cell is effected. Scale normalization, low-pass filtering, low-cut filtering directional image calculation and smoothing are processes that are realizable by those of ordinary skill in the art. Accordingly, detailed discussions thereof are omitted.

The quality Q of a print image data FP is then calculated by determining a ratio of cells that remain substantially unchanged following the smoothing and quality processing step 320 to the total number of cells. This ratio is then squared and multiplied by the area of the print image data FP divided by the area of the entire scanned image. Thus, both the quality of the print image data FP and absence of image data corresponding to a fingerprint are taken into consideration. Quality decision step 325 is then executed to determine whether the quality Q of the print image FP is above a given quality threshold. When the quality Q is below the given quality threshold, the process returns to the imaging step 300 for input of new data. This is because it is determined that the quality of the fingerprint is insufficient to base matching upon. If the quality is above the given threshold, processing proceeds a binarization step 330.

In the binarization step 330, the image data FP shown in FIG. 8(a) is subjected to preliminary binarization using subtraction of low-pass filtering resulting in the image data FP producing the image shown in FIG. 8(b), followed by directional filtering and binarization resulting in the image of FIG. 8(c). Processing continues with execution of a skeletonization step 335 wherein the image data FP is subjected to a thinning and skeletonization processing wherein all ridge lines are reduced to a width of one pixel which results in the image shown in FIG. 8(d). In this stage visible ridge lines, that are some pixels in width, are being changed to lines one pixel in width. The values on the ridge lines are 1 and for all other areas the values are 0. Now the matrix consists of only two values. Detailed discussions of the filtering and skeletonization processes are omitted as such are realizable by those of ordinary skill in the art given the present disclosure.

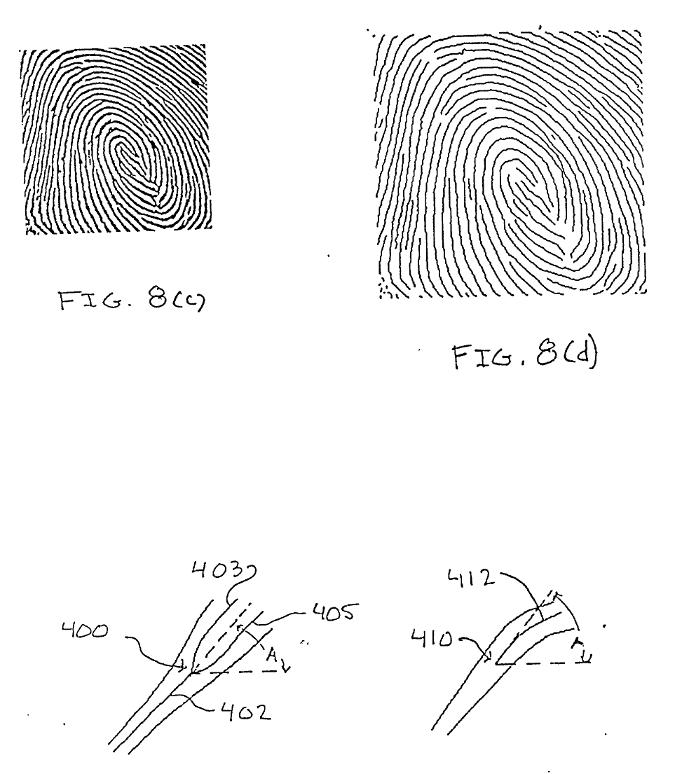

A minutia extraction step 340 is next executed upon the image data FP that has been skeletonized. Fingerprints are characterized by various minutia which are particular patterns of the ridges. Two basic types of minutia are a bifurcation 400, or branch, shown in FIG. 9(a), wherein a ridge line 402 divides into two ridge lines, 403 and 405, and an end 410, shown in FIG. 9(b), wherein a ridge line 412 ends. Each minutia is characterized as a vector represented by a minutia data triplet X, Y, and A wherein X and Y represent the location of the minutia and A is an angle of a vector of the directionallization of the minutia as shown in FIGS. 9(a) and 9(b).

In a preferred embodiment of the present invention, distinction between end minutia 410 and bifurcation minutia 400 is not made. It is found that exclusion of such distinction results in reduction of data, reduced processing needs and time, while still providing acceptable reliability of fingerprint comparison. Alternatively, distinction may be made with associated increase in processing. Also, as will be described, pseudo minutia points may also be generated to provide further reliability of the comparison, especially when less than ideal amounts of traditional characteristic data can be collected.

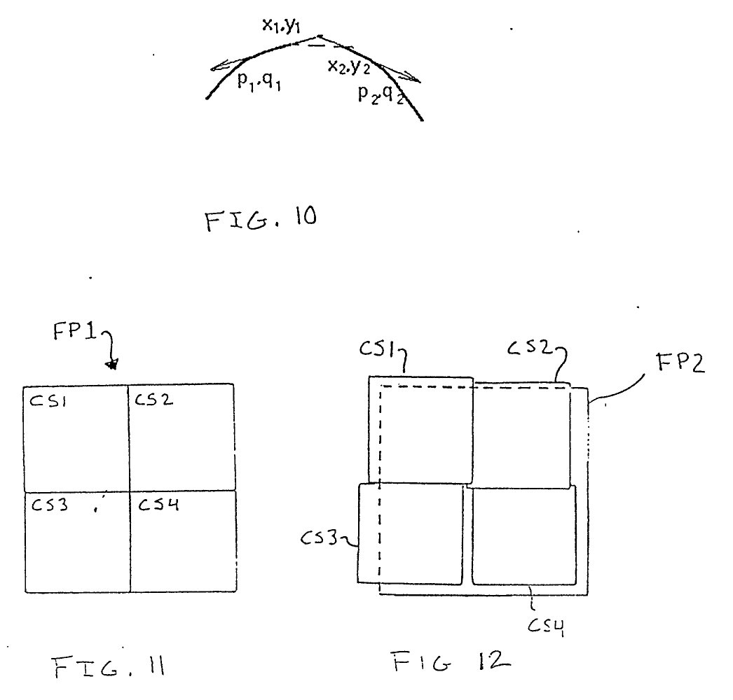

The minutia extraction step 340 further proceeds with exclusion of minutia that are too closely located. Referring to FIG. 10, two end minutia at (x1, y1) and (x2, y2), respectively, and represented by vectors (p1,q1) and (p2,q2), respectively, are shown. First, determination is made as to whether the two minutia are within a threshold distance. This threshold distance is optionally a distance r used to determine matching minutia and discussed below, a fixed distance, or another distance based on mean ridge line separation distance. When two minutia are within the given threshold distance, a determination is made whether the angle between the two vectors (p1,q1) and (p2,q2) is within a given threshold of 180° and the angle between (p2,q2) and (x2−x1, y2−y1) is within a given threshold of 0. If two minutia satisfy the aforesaid criteria they are excluded because they are too close and aligned in a nearly straight line. As a result of the minutia extraction process, the print image FP is now represented by a data set defined as FP={Q, N, F(i,j), X(k), Y(k), A(k)} wherein N is the total number of minutia for the fingerprint FP, and X(k), Y(K) and A(k) are the data triplet representing the k-th minutia. The minutia extraction is advantageous in reducing the amount of data to be processed and thereby reducing the processing time and requirements.

Furthermore, although it is beneficial to recue the amount of data through minutia extraction, in some instances, and with certain methods and systems for the generation of the image data FP, an initial sampling of insufficient size and/or with insufficient identifiable and/or useable minutia may be all that is available. In such a situation, the mere use of the available minutia in the matching or comparison steps may provide unacceptable accuracy levels and/or can lead to false approvals or matches. Naturally, such is wholly unacceptable given the high degree of security and monitoring that is being sought through the utilization of biometric scanning and the critical nature of generating false approvals. Still, however, with certain applications and utilizing certain types of image data FP generating systems, all that is available is the reduced quantity minutia sampling.

Accordingly, in a further embodiment of the present invention, in order to substantially avoid such limits on effective data comparison, and especially when alternate types of biometric scanning surfaces, such as previously described, are integrated into the biometric input device, an alternate system and method of the present invention provides for the generation and/or identification of additional comparison characteristics, apart from the available minutia points, which can be effectively utilized in the comparison method and/or algorithm. In such an embodiment, at least two, preferably adjacent and/or closely spaced ones of the minutia points are identified from the minutia data. Of course, if more minutia points are available, they may also be identified and utilized for comparison purposes. In those instances, however, wherein insufficient minutia points are available for secure and effective authentification, the system and method of the present invention may be configured to identify a connecting pattern between two preferably adjacent minutia points, such as minutia points M1 and M2 in FIG. 14, as generally defined by the fingerprint ridge therebetween. Specifically, each fingerprint, as indicated includes a specific ridge pattern that is characterized by the minutia points. The present invention recognizes, however, that the connecting pattern of ridges between what is generally identified as the minutia points also provides certain characteristic identifiers of the fingerprint. Also, it is recognized that more than one connecting pattern may be identified between one or more pairs of minutia points, however, in most instances all that is necessary, and for purposes of clarity in explanation, only a single connecting pattern need be identified. That connecting pattern, nevertheless, provides the basis for the identification of additional comparison characteristics to be utilized within the comparison system and algorithm.

In particular, the connecting pattern is preferably divided into a plurality of pseudo minutia points. The exact number of the pseudo minutia points can depend upon the number of additional minutia points available for proper authentification, and may preferably, although not necessarily, be produced by dividing the connecting ridge into a series of equal length segments. For example, if only two or a very small number of minutia points are initially identified, then a larger number of pseudo minutia points are preferred to provide a sufficient number of comparison characteristics; however, if a sufficient number of minutia points can be identified, a small number, if any, pseudo minutia points can be separated within any given connecting pattern. Furthermore, if desired, the pseudo minutia points can be provided so as to generally define, such as utilizing standard extrapolation, a contour of the connecting pattern. If desired, the contour of the connecting pattern, instead of or in addition to the pseudo minutia points themselves, can be utilized as the necessary comparison characteristics.

As a result, from the preceding it is seen that within the system and method of the present invention, proper and secure authentification can take place, even if a small scanning surface is provided, such as in a compact or less costly device. Moreover, such significantly expands the possibilities for the applicability of a biometric authentification to permit and/or restrict access. Also, based upon the preceding, it is recognized that as used herein within the context of the previously described algorithm and comparison method, and/or any alternate comparison system or algorithm, the terms minutia point and/or minutia can include not only a minutia point, but also a combination of minutia points, connecting pattern and pseudo minutia point data, and the data set of the print image FP may likewise be obtained utilizing any combination thereof, as necessary.

With an embodiment of the present invention, processing next proceeds to a matching process step 345 wherein the print image data FP is compared to image data in the database. FP1 now refers to the image data of the input fingerprint and FP2 refers to print image data of a fingerprint retrieved from the database in database retrieval step 347. Likewise in this description, other variables are appended with 1 or 2 to represent the respective fingerprint.

It is preferable to find the best alignment of the directional images DI1 and DI2 of F1(i,j) and F2(i,j). Data F1(fa, fdx, fdy) (i,j) is now calculated wherein rotation by angle fa and shift by distance fx and fy is effected in an orthogonal transformation of F1(i,j). After the transformation of F1, a comparison of F1(fa, fdx, fdy) (i,j) with F2(i,j) is then made wherein differences in orientations of corresponding cells of the directional images D1 and D2 is calculated as DifDI. DifDI is calculated as the sum of all angular differences between corresponding cells. The values of fa, fdx, fdy iteratively varied and for each permutation thereof the transformation of F1(fa, fdx, fdy) (i,j) is made and compared with F2(i,j) to find a DifDI for each set of fa, fdx, fdy values. A set of fa, fdx, fdy values is then chosen for which DifDI is minimal. The chosen set of fa, fdx, fdy represent the best shifting parameters for shifting the directional image D1 to effect the best matching directional alignment of D1 and D2. Subsequent alignment of minutia for matching purposes used the chosen set of fa, fdx, fdy as a starting point for adjustments. Additionally, BI is determined as the number of cells (i,j) of either D1 or D2 that are not UnDir.

A directional difference decision step 350 is next executed wherein the minimal DifDI for the chosen set of fa, fdx fdy is compared against a threshold DifDI_{TH} which may be a set threshold or threshold based on BI. If DifDI exceeds the threshold DifDI_{TH}, then it is determined that the correspondence level, or matching level, between the directional images is insufficient to warrant further comparison of FP1 and FP2 and a different fingerprint image data is chosen for FP2 and processing returns to the beginning of the matching process step 345. If DifDI is less than the threshold, operation proceeds to similarity measure calculation step 355.

Next, the chosen set of fa, fdx, fdy for orthogonal transformation is applied as (dfx*Fstepx, dfy*Fstepy and fa) to the minutia data triplets X1(k), Y1(k), and A1(k) of FP1, where k represents a k-th minutia. The transformed minutia data triplets of print image data FP1 are then grouped into clusters each containing not less than a given number of minutia, preferably seven. Referring to FIG. 11(a), FP1 is illustrated as being divided in four clusters CS1, CS2, CS3, and CS4, which each contain the given number of minutia (not shown). FIG. 11(a) is a simplified depiction of the process in that the clusters do not necessarily cover square regions of the print image and the number of clusters is not limited to four. The clusters may be thought of a regional groupings of minutia.

Referring now to FIG. 11(b), for each of the clusters CS1, CS2, CS3, and CS4 on a cluster by cluster basis, X1(k), Y1(k) of the minutia of the given cluster are all iteratively shifted in x and y directions by values dr, wherein dr is varied within a range R, such that abs(dr)<R, and a comparison of the shifted X1(k), Y1(k), A1(k) is made against all minutia in a BI grouping of FP2 for each set of dr set values to identify minutia of FP1 matching those of FP2. A pair of minutia are considered matched when a distance between them is less than a threshold r discussed below. The BI grouping of FP2 is the group of cells in FP2 that are not UnDir. For each shift of a cluster, a similarity measure Smt is taken, which is the sum of the following term for each set of matched minutia in the cluster:

$$m ( x1 , y1 ; x2 , y2 ) = a {\int }_{o}^{d} {exp ( - z / 2 ) ⅆ z + δ}_{δ} ,$$

where

d=(x1−x2)²+(y1−y2)²

and a, δ and 0 are empirical values. In an embodiment of the invention, a is 150, δ is set equal to R1, where R1 equals 30, and R2, where R2, equals 20, R1 and R2 being discussed below, and 0 is set equal to 4. These values are exemplary and alterable without departing from the scope and spirit of the present invention. For each cluster, the set of dr values yielding the greatest similarity measure Smt is selected and the total sum of the greatest similarity measure of each cluster is taken to find a similarity measure Smt(FP1, FP2) for the comparison of FP2 to FP2).

As noted above, comparison of fingerprints is often hampered by various environmental and physiological factors. The division of FP1 into clusters provides compensation in part for such factors as stretching and shrinking of the skin. For a given cluster, the total distance difference due to stretching or shrinkage between two minutia is limited due to the limited size of the cluster area. Thus, adverse effects of shrinking and stretching are minimized. Accordingly, individual cluster shifting and comparison are a preferred embodiment of the present invention. Alternatively, division of FP1 into clusters may be omitted and shifting and comparison of FP1 as a whole effected.

The maximum similarity measure Smt(FP1, FP2) is generated for the best comparisons of all clusters of FP1 with FP2, along with a number Nmat of matched minutia, and a number Ntot which is the total number of minutia within the BI grouping of FP1. An overall similarity measure for the comparison of FP1 with FP2 is calculated as follows:

Nmt(R,r,BI,Ntot)=Smt(FP1, FP2)−DifDI

where Smt(FP1, FP2) is a sum of the best Smt of each cluster. Thus, this takes into account the maximal number of matched minutia, DifDI and statistical peculiarities of distances distribution.

Processing then proceeds to similarity decision step 360 wherein Nmt(R, r, BI, Ntot) is compared with a threshold Thr (R, r, BI, Ntot). If Nmt(R, r, BI, Ntot) is greater than the threshold Thr(R, r, BI, Ntot), it is determined the FP1 matches FP2 and a match is indicated in match indication step 365. If Nmt(R, r, BI, Ntot) is less than or equal to the threshold Thr(R, r, BI, Ntot) it is determined the FP1 does not match FP2 and execution proceeds to the data base retrieval step 347 for the selection of another set of print data from the database for use as FP2 in the process which returns to the matching process step 345. Indication of a match is then used to permit access to the computer 50 in general or specific functions thereof.

In a preferred embodiment of the invention, the threshold Thr(R, r, BI, Ntot) is determined on the basis of threshold training using a sample pool of fingerprints from a number of individuals. The sample pool is composed of a number of samples, or standards, from each individual in the pool. The number of samples, from each individual in the pool. The number of samples from each individual in one example is 4 and the number of individuals is in a range of 100 to 1000. The number of samples and individuals may be varied from the exemplary values and range without departing from the scope and spirit of the present invention. The process steps 305 through 355 of FIG. 6 are then executed for each print with every print being compared to every other print. Since the sample pool is known, comparisons of prints from a same individual and comparisons of prints from different individuals are known.

In performing the threshold training, n number of variations of R and r are used and are shown below as R1, R2 and r1, r2 for an example where n=2. For example, values are set such that R1<R2 and r1<r2 where R1=2*MID, r1=MID, R2=3.5-4 MID, and r2=2*MID. MID is the mean inter-ridge distance of the prints in the sample pool. The following values are found:

NmtS(R1,r1,BI,Ntot), NmtA(R1,r1,BI,Ntot), and

NmtS(R2,r2,BI,Ntot), NmtA(R2,r2,BI,Ntot),

where NmtS is number of matched minutia for prints compared from the same individual while NmtA is the number of matching minutia resulting from the comparison of fingerprints from different individuals.

For a given BI,Ntot (within subrange of appropriate quantization), BestA(n,BI,Nmat) is set to the max NmtA(Rn,rn,BI,Ntot), of all the comparisons of fingerprints from different individuals, and MinNmtS(Rn,rn,BI,Ntot) is set to the minimum NmtS(Rn,rn,BI,Ntot) of all comparisons of fingerprints from the same individual for n=1,2, etc. The threshold are then calculated as follows:

Thr(n,BI,Nmat)=(BestA(n, . . . )=MinNmtS(Rn,rn, . . . ),

where

NmtS(Rn, . . . )>BestA(Rn, . . . )/2.

In conjunction with the above discussion of threshold calculations, the similarity decision step 360 produces a positive match indication if for the current BI, Ntot:

Nmt(R1,r1,BI,Ntot)>Thr(1,BI,Ntot), or

Nmt(R2,r2,BI,Ntot)>Thr(2,BI,Ntot).

If this condition is not found, then the dichotomy analysis gives some correction. The results of identical and not identical matchings is considered as two classes of patterns and the pairs of values Nmt(R1,r1, . . . ), Nmt(R2,r2, . . . ) as feature coordinates. The dichotomies are performed by the second order threshold functions which are calculated according to chapter 2.3. in the classical book by J.Tu and R. Gonzalez “Pattern Recognition Principles” Addison-Wesley Publ. 1974, which is incorporated herein by reference for its relevant dichotomy teachings.

The complete description to be stored in the database is a multilevel structure of 4 (or more) FP data sets taken from the different applications of the same FP. Each level of the structure corresponds to minutia appearance frequencies for all FP codes.

Optionally, instead of using thresholds for the similarity comparison as discussed above, fixed values may be chosen and used as threshold values.

The data base of fingerprints of individuals for whom identification is required is created by a registration process. The registration process entails a given individual having their fingerprints scanned a number of times, for example four. Of the four scans, the scanning producing the greatest number of minutia is then selected for the database.

The present invention further includes use of the above fingerprint minutia extraction and comparison process, either using minutia points alone, and/or a combination of minutia points and pseudo minutia points, in conjunction with a cryptographic protection process. For this aspect of the invention, the computer 50, also referred to as the client, will send fingerprint data to the remote computer 51, also referred to as the server, over the link 53 which may be, for example, a link over the Internet. Thus, security protection for data sent over the link 53 is required.

There are three different cryptographic procedures used in the cryptographic process. As they are not used simultaneously, they are described below separately. All cryptographic parts are written in italic font. The cryptographic method employed is RSA encryption.

I. User Registration

In order to use the cryptographic process, the user must first register his fingerprint with the server. In order to maintain security, the fingerprint data must be encrypted to prevent unauthorized interception thereof. The following steps are used:

1. User fills in a registration form including a UserID. Other information such as Name, E-mail address, etc. may be included.

2. User scans his fingerprint into the computer 50 via the biometric input device where it is stored as image data. The image data is typically on the order of 64 KB.

3. The computer 50 then converts the image data of the finger to the data set defined as FP={Q, N, F(i,j), X(k), Y(k), A(k) using processing steps 310 through 340 shown in FIG. 6. This data set is also referred to herein as a passport. Optionally, components of the data set may be omitted, such as F(i,j), so the passport may be shortened to about 1.2 KB.

4. The client, computer 50, then sends a request for the public key to the server via the link 53.

5. Server sends its public key K_{E} via the link 53.

6. Client encrypts its passport and his UserID using RSA algorithm and public key K_{E}. In a preferred embodiment the length of the key is 512 bits: C=RSA.Encode Public (K_{E}, passport, UserID)

7. The computer 50 sends C to the remote computer 51 via the link 53.

8. The remote computer 51 decrypts message using its secret key K_{D}:

M=Passport+UserID=RSA.Encode Secret (K_{D}, C)

9. The remote computer 51 then adds the UserID and passport to the database.

II. User Authorization

The user authorization process is used where a user wishes to gain access to the remote computer on the basis of his finger print matching one in the database.

1. User scans his fingerprint image data into the computer 50.

2. The computer converts the image of the finger to the passport using processing steps 310 through 340 shown in FIG. 6.

3. The computer 50 sends a request over the link 53 to the remote computer 51, the server, for the public key to the server.

4. The remote computer 51 sends its public key K_{E} to the computer 50.

5. The computer 50 encrypts the passport and UserID using RSA algorithm using the public key K_{E}:

C=RSA EncodePublic (K_{E}, passport, UserID)

6. The computer 50 sends C to the remote computer 51 via the link 53.

7. The remote computer 51 decrypts message using its secret key K_{D}:

M=passport+UserID=RSA EncodeSecret (K_{D}, C)

9. The remote computer 51 then searches the database for the UserID, finds the corresponding passport, and executes steps 345 through 365 of FIG. 6 using the passport retrieved from the database as FP2. Optionally, step 350 is omitted. If the comparison of step 360 is positive, access is authorized. If the UserID does not exist or the comparison result of step 360 negative, authorization for access is refused.

III. Installation of the Server and Addition of New Users is Effected by the Following Steps:

1. Installation of normal Web-server components.

2. Generation of the public and secret keys for the administrator of the server: first of all random integer is generated, possibly based on administrator's fingerprint, which is part random, then the deterministic algorithm is started to determine public and secret keys.

3. When the new user is being registered, server takes its UserID and passport and encrypts them with administrator's public key.

Usage of two different keys makes it more difficult to corrupt fingerprint data since an intruder must obtain both public and private keys to complete his attack. Different servers will have different keys to ensure that corrupted fingerprint data (i.e. stolen from some server) could not be used on other servers.

The 512-bits RSA keys are extremely difficult to crack. In fact, the keys of that length are not known to have been broken, so current cryptography declares them as keys for long-term secret information (30-50 years or longer). Average time of encryption of passport (client side) is less than a second. Average time of decryption of passport (server side) is about 2 seconds, so it is reasonable to predict that network delays would be more significant. Besides, servers are usually more powerful than the client computers.

A further aspect of the present invention provides software for working in the Windows environment. In particular, a protection icon is provided which an authorized user, one whose passport has produced a positive comparison, may move and drop on a file or program object to require that future access thereto be permitted only when a positive fingerprint comparison has been executed. Optionally, the user may input a list of UserID's for whom access will be allowed.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

Now that the invention has been described,

What is claimed is:

1. A method of analyzing a fingerprint, said method comprising the steps of:
placing a finger on a fingerprint sampling area of a biometric input device;
detecting fingerprint data from the fingerprint sample area;
identifying minutia points in said fingerprint data;
identifying a connecting pattern between at least two of said minutia points; and
utilizing at least a portion of said connecting pattern to define characteristics to distinguish the fingerprint.

2. A method of analyzing a fingerprint as recited in claim 1 wherein said step of placing a finger on a fingerprint sampling area of a biometric input device further comprises placing a finger on a fingerprint sampling area of reduced dimensions.

3. A method of analyzing a fingerprint as recited in claim 2 wherein said step of placing a finger on a fingerprint sampling area of reduced dimensions further comprises placing a finger on a fingerprint sampling area that is smaller than a fingerprint surface area of the finger.

4. A method of analyzing a fingerprint as recited in claim 1 wherein said step of detecting fingerprint data from the fingerprint sample area further comprises the step of detecting a fingerprint image of reduced dimension.

5. A method of analyzing a fingerprint as recited in claim 1 wherein said step of identifying said minutia points in said fingerprint data further comprises identifying at least two adjacent ones of said minutia points.

6. A method of analyzing a fingerprint as recited in claim 5 wherein said step of identifying a connecting pattern between said minutia points further comprises identifying said connecting pattern between said adjacent minutia points.

7. A method of analyzing a fingerprint as recited in claim 1 further comprising a step of separating said connecting pattern into a plurality of pseudo minutia points.

8. A method of analyzing a fingerprint as recited in claim 7 wherein said step of utilizing at least a portion of said connecting pattern as characteristics to distinguish the fingerprint further comprises utilizing said pseudo minutia points as said characteristics to distinguish the fingerprint.

9. A method of analyzing a fingerprint as recited in claim 7 wherein said step of separating said connecting pattern into a plurality of pseudo minutia points further comprises separating said connecting pattern into a number of pseudo minutia points based upon a number of said minutia points identified.

10. A method of analyzing a fingerprint as recited in claim 1 wherein said step of utilizing at least a portion of said connecting pattern as characteristics to distinguish the fingerprint further comprises utilizing said pseudo minutia points to substantially define a contour of said connecting pattern as said characteristics to distinguish the fingerprint.

11. A method of analyzing a fingerprint, said method comprising the steps of:
placing a finger on a fingerprint sampling area of a biometric input device;
detecting fingerprint data from the fingerprint sample area;
identifying minutia points in said fingerprint data;
identifying a connecting pattern between at least adjacent ones of said minutia points;
separating said connecting pattern into a plurality of pseudo minutia points;
utilizing said pseudo minutia points to define characteristics to distinguish the fingerprint.
